(19) United States
(12) Patent Application Publication
(10) Pub. No.: US 2023/0403782 A1
(43) Pub. Date: Dec. 14, 2023

(54) PLASMA TORCH WITH IMPROVED COOLING SYSTEM AND RELATED COOLING METHOD

(71) Applicant: TRAFIMET GROUP S.P.A., Castegnero (VI) (IT)

(72) Inventors: Claudio BENETTI, Quinto Vicentino (VI) (IT); Paolo Francesco GARAVAGLIA, Verona (VR) (IT)

(73) Assignee: TRAFIMET GROUP S.P.A., Castegnero (VI) (IT)

(21) Appl. No.: 18/030,963

(22) PCT Filed: Oct. 5, 2021
(86) PCT No.: PCT/IB2021/059108

§ 371 Date: Apr. 7, 2023

(30) Foreign Application Priority Data
Oct. 15, 2020 (IT) 102020000024391

(51) Int. Cl. H05H 1/28

(52) U.S. Cl. CPC H05H 1/28

(57) ABSTRACT

A plasma torch includes a first element provided with a through opening for the exit of a plasma flow, and a hollow electrode which develops longitudinally along a main axis and can be positioned with respect to the first element in such a way as to define a striking area. The hollow electrode includes an inner cavity which extends at least partially along the main axis and a main conveyance way suited to convey a carrier gas. The torch includes a first divider suited to divide the main way into a first conveyance way suited to convey a portion of the carrier gas from the main way towards the striking area and into a second conveyance way suited to convey a portion of the carrier gas from the main way towards the inner cavity of the hollow electrode, the portion of carrier gas of the second way being suited to cool down the hollow electrode, and a second divider arranged downstream of the first divider, suited to divide the first way into a third conveyance way suited to convey a portion of the carrier gas from the first way towards the striking area and into a fourth conveyance way suited to convey a portion of the carrier gas from the first way towards the first element, the portion of carrier gas of the fourth way being suited to cool down the first element.

### TECHNICAL FIELD OF THE INVENTION

The present invention concerns the construction of a plasma torch used in industrial applications.

More specifically, the present invention concerns the cooling system used to cool down the components of said torch.

The present invention concerns also a device using said torch.

### DESCRIPTION OF THE STATE OF THE ART

The use of technologies for processing materials, typically metallic materials, is known in several sectors, and especially in the industrial sector. Said processing treatments typically consist in the cutting and/or marking of the materials.

According to the known technologies, special plasma devices are used by specialist operators to process materials.

Said known devices exploit the effect deriving from the generation of an electric arc between two electrodes, known as cathode and anode. The device generates a plasma flow which exits from a nozzle following the application of a suitable difference in potential and the striking of the arc between the two electrodes between which a carrier gas, typically air, flows. The carrier gas is subjected to ionization in order to generate said plasma.

For this purpose, said devices comprise an element that can be handled by the operator, known under the name of torch, at the end of which there is a nozzle provided with an orifice which collimates the plasma flow and conveys it towards the outside.

In a first type of torches, known for example as transferred arc torches, the arc is initially struck between an electrode, the cathode, positioned in the torch, and the nozzle, which thus initially serves the function of an anode. After the initial striking step, the function of anode is transferred to the piece being processed, while the nozzle serves only as a collimator and conveyor of the plasma flow.

In a second type of torches, known as non-transferred arc torches, instead, the nozzle always serves the function of an anode, both during the initial striking step and during the operation of the torch while the piece is being processed.

In metal cutting processes, given the higher energy density transferred to the piece, the transferred arc configuration is adopted, while the non-transferred arc configuration remains the only choice for the processing of non-metallic materials.

The plasma flow, however, is generated through interaction with the carrier gas flow which is conveniently conveyed at the level of the electrodes.

For its operation, therefore, the device is made up of a first unit, or generator, suited to supply power to the torch to generate and maintain the arc, and a unit suited to feed the torch with the carrier gas.

According to the known technique, the end of the torch is thus equipped with a first element, or nozzle, provided with an opening from which the plasma flows out in the form of a jet. As explained above, the first element furthermore serves as an anode for generating and/or maintaining the plasma. At the end of the torch there is also a second element or internal electrode (cathode) which constitutes the other electrode for the generation of the plasma. The internal electrode is typically arranged coaxially inside the nozzle.

In a first category of torches of the known type, the internal electrode can slide axially with respect to the nozzle under the influence of an elastic force which is usually provided by a spring. The axial movement of the internal electrode is such as to define, first of all, a first position in which no striking occurs, with the internal electrode in contact with the nozzle, and thus a position in which no plasma flows out of the nozzle. The axial movement of the internal electrode against the thrusting force of the spring and away from the nozzle is such to define, successively, a second position in which the arc is struck and in which the internal electrode is arranged at a suitable distance from the nozzle and the plasma jet can be emitted from the orifice provided in the nozzle when the carrier gas is conveyed inside it.

Typically, the movement of the internal electrode away from the nozzle against the thrusting force of the spring is obtained through the convenient conveyance of the same flow of carrier gas against suitable surfaces of the internal electrode or, more specifically, against suitable surfaces of a piston which supports the electrode itself.

In a different type of torches of the known type, the internal electrode and the nozzle are kept at a suitable fixed striking distance. To generate the plasma jet that is emitted by the nozzle, the carrier gas is conveyed between the two electrodes and power is conveniently supplied to the two electrodes to generate an alternate electric field and thus a high frequency discharge between them.

Independently of the type of torch used, the high temperatures involved in the striking area at the level of the electrodes make the construction of the electrodes a particularly important aspect for the operation and duration of the torch itself.

In fact, the electrodes, and especially the internal electrode, wear out very quickly.

More specifically, electrodes wear out due to different factors: high intensity of the current feeding the arc during the cutting process and heating the electrode; frequency of the switch on/switch off cycles; heat irradiated towards the electrode itself by the piece being processed.

For this purpose, according to the known technique, during operation the electrodes are subjected to a cooling process. Special attention is paid to the construction and cooling of the internal electrode.

In a first type of torch, the internal electrode is of the hollow type. This solution uses a smaller quantity of material, typically copper, compared to the solutions with solid electrodes. Advantageously, this solution with hollow internal electrodes is less expensive. The electrode, however, is subject to high wear over time, due especially to the high temperatures involved. In order to extend the operating life of the internal electrode, a cooling system is used which conveys at least part of the carrier gas flow, before the arc is struck, into the cavity present inside the electrode. The carrier gas cooling flow touches the inner walls of the cavity of the electrode, producing a cooling action for the electrode itself.

According to the known technique, furthermore, the cooling flow which involved the inner cavity of the electrode is conveyed towards the outside once again and moves through the striking area where the plasma is generated and thus towards the outlet orifice of the nozzle.

The cooling system of the known type described above, however, has some drawbacks.

A drawback of this type of cooling lies in that the cooling action is not efficient, as the cooling gas flow which exits from the hollow electrode has undergone a heating effect and returns towards the striking area between the electrodes.

The effect of the temperature of the cooling gas thus adds to the effect of the temperature in the striking area.

Another drawback of the systems of the known type is the high wear of the electrodes, in particular the internal electrode, especially at the level of the striking area.

A further drawback of the systems of the known type is constituted by the low effectiveness of the plasma, which is caused by the increase in the temperature of the carrier gas which is ionized. It is known, in fact, that the lower the temperature of the ionized gas, the higher the density of the plasma. A temperature increase, therefore, reduces the density and consequently the effectiveness of the plasma.

It is the object of the present invention to overcome the said drawbacks at least partially.

It is a first object of the present invention to provide a plasma torch equipped with a cooling system which is more effective than the systems of the known type, at the same time guaranteeing a flow of gas to be ionized at low temperature, in order to generate high density plasma.

It is another object of the present invention to provide a plasma torch which requires fewer electrode maintenance and/or replacement operations, in particular for the internal electrode, compared to the torches of the known type.

It is a further object of the present invention to provide a plasma torch which makes it possible to obtain high flow rates of cutting air resulting in higher cutting speeds and therefore better quality of the cut piece (that is, with fewer burrs).

It is a further object of the present invention to provide a plasma torch producing more effective plasma compared to the torches of the known type.

### SUMMARY OF THE PRESENT INVENTION

The general concept on which the present invention is based has been developed starting from the intention to provide a plasma torch comprising a hollow electrode and equipped with a system for cooling the hollow electrode by conveying a cooling fluid into its inner cavity, wherein the cooling fluid is ejected from the torch after flowing through the inner cavity of the electrode in an area not affecting the striking area.

According to a first aspect of the present invention, therefore, the same concerns a plasma torch made according to claim 1.

Preferably, the plasma torch comprises:
a first element provided with a through opening for the exit of a plasma flow;
a hollow electrode that develops longitudinally along a main axis and can be positioned with respect to said first element in such a way as to define a striking area, said hollow electrode being of the type comprising an inner cavity that extends at least partially along said main axis;
a main conveyance way suited to convey a carrier gas; wherein the torch comprises:
first dividing means suited to divide said main way into a first conveyance way suited to convey a portion of said carrier gas from said main way towards said striking area and into a second conveyance way suited to convey a portion of said carrier gas from said main way towards said inner cavity of said hollow electrode, said portion of said carrier gas of said second way being suited to cool down said hollow electrode, and the entirety of said portion of said carrier gas of said second way being conveyed from said inner cavity of said hollow electrode towards an outlet way so as not to affect said striking area;
second dividing means arranged downstream of said first dividing means and suited to divide said first way into a third conveyance way suited to convey a portion of said carrier gas from said first way towards said striking area and into a fourth conveyance way suited to convey a portion of said carrier gas from said first way towards said first element, said portion of said carrier gas of said fourth way being suited to cool down said first element.

Preferably, the carrier gas from the inner cavity of the hollow electrode in the second way is conveyed towards the outside of the torch, in such a way as not to affect the striking area.

Preferably, the inner cavity of the hollow electrode substantially extends over the entire length of the hollow electrode itself.

In a preferred embodiment, the hollow electrode constitutes the cathode of the torch.

In a preferred embodiment, the hollow electrode constitutes the cathode of the torch, and the first element constitutes the anode of the torch during the striking step. In said embodiment, after said striking step the first element does not serve as the anode of the torch any longer and the task of serving as the anode is transferred to and defined by the piece being processed.

In another preferred embodiment, the hollow electrode constitutes the cathode of the torch, and the first element constitutes the anode of the torch during all the processing steps.

According to a preferred embodiment, the hollow electrode is movable and can be positioned between at least one first operating position and at least one second operating position. In the first operating position the hollow electrode is in contact with the first element and in the second operating position the hollow electrode is spaced from the first element in such a way as to define the striking area.

The torch conveniently comprises moving means for moving the hollow electrode between the first operating position and the second operating position.

Preferably, the moving means comprise at least one piston supporting the hollow electrode and elastic thrusting means suited to thrust the piston and to arrange the hollow electrode in the first operating position.

According to another preferred embodiment, the hollow electrode is in a fixed position with respect to the first element.

The torch conveniently comprises power supply means for the hollow electrode.

The torch conveniently comprises power supply means for the first element.

The torch preferably comprises also carrier gas feeding means.

According to a second aspect of the present invention, the same refers to a device for the generation of plasma comprising a plasma torch, wherein the torch is made as previously described.

Preferably, said device comprises power supply means for said torch.

Preferably, said device comprises feeding means for feeding said torch with a carrier gas.

According to a third aspect of the present invention, the same refers to an operating method for a plasma torch of the type comprising:
a first element provided with a through opening for the exit of a plasma flow;
a hollow electrode which develops longitudinally along a main axis and can be positioned with respect to said first element in such a way as to define a striking area, said hollow electrode being of the type comprising an inner cavity which at least partially extends along said main axis;
a main conveyance way for conveying a carrier gas; said method comprising at least the following steps:
conveying a portion of said carrier gas from said main way towards said striking area along a first way and conveying a portion of said carrier gas from said main way towards said inner cavity of said hollow electrode to cool down said hollow electrode along a second way, the entirety of said portion of said carrier gas being conveyed from said inner cavity of said hollow electrode towards an outlet way so as not to affect said striking area;
conveying a portion of said carrier gas from said first way towards said striking area along a third way and conveying a portion of said carrier gas from said first way towards said first element along a fourth way, said portion of said carrier gas of said fourth way being suited to cool down said first element.

### BRIEF DESCRIPTION OF THE FIGURES

Further advantages, objectives and characteristics of the present invention are defined in the claims and will be clarified below through the following description with reference to the attached drawings. More specifically, in the drawings:

FIG. 1 shows a side plan view of a torch according to a preferred embodiment of the present invention;

FIG. 2 shows a top view of the torch of FIG. 1;

FIG. 3 shows a schematic sectional view along line III-III of FIG. 2, with the torch in a first operating position;

FIG. 4 shows a schematic sectional view along line III-III of FIG. 2, with the torch in a second operating position;

FIG. 4A shows an enlarged view of a first detail of FIG. 4;

FIG. 4B shows an enlarged view of a second detail of FIG. 4;

FIG. 5 shows the same schematic view shown in FIG. 4, with indication of some flows occurring during the operation of the torch in the second operating position;

FIG. 6 shows a schematic sectional view along line VI-VI of FIG. 2, with the torch in the second operating position, with indication of some flows occurring during the operation of the torch.

### DETAILED DESCRIPTION OF THE PRESENT INVENTION

Even though the present invention is described below with reference to its embodiment illustrated in the drawings, the present invention is not limited to the specific embodiment described below and illustrated in the drawings. On the contrary, the embodiment described and illustrated clarifies some aspects of the present invention, the scope of which is defined in the claims.

The present invention has resulted to be particularly advantageous with reference to the construction of plasma torches of the type with transferred arc using a gas cooling system. It should however be underlined that the present invention is not limited to the construction of torches of that type. On the contrary, the present invention can be conveniently applied in all those cases in which plasma torches with gas cooling are used, for example also in the case of non-transferred arc plasma torches.

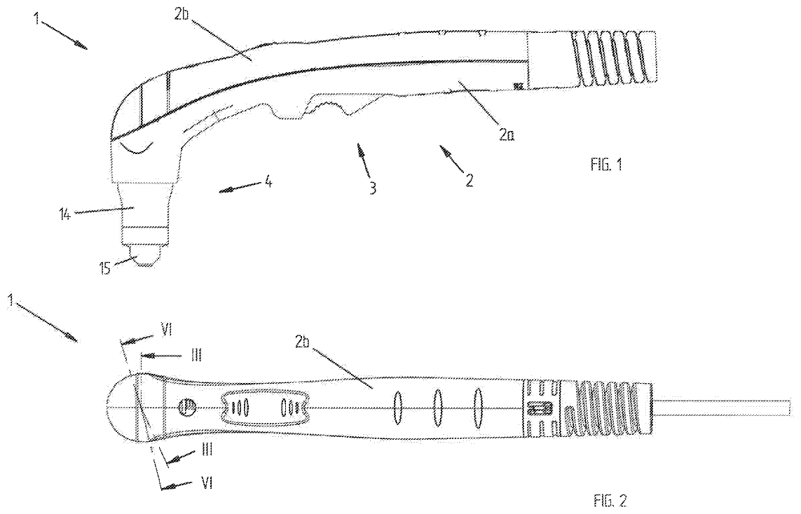

FIGS. 1 and 2 show a torch according to a preferred embodiment of the invention, indicated as a whole by 1.

The torch 1 constitutes the handleable element of a plasma treatment device comprising also a power supply unit and a carrier gas feeding unit, not illustrated, for the torch 1.

More specifically, the torch 1 constitutes the handleable element of a plasma cutting device.

The carrier gas preferably comprises air and is conveyed to the torch 1 by the carrier gas feeding unit through a suitable duct.

Preferably, the carrier gas is pushed, under pressure, towards the torch 1 and the carrier gas feeding unit is advantageously constituted by an air compressor and/or a compressed air tank.

In variant embodiments, however, the carrier gas can be of a different type such as, for example, nitrogen (N2), an argon-nitrogen mixture (for example, 65% argon and 35% nitrogen), oxygen (O2), etc.

For the sake of simplicity, in the continuation of the description the carrier gas can also be simply referred to as “air” or “compressed air”.

The torch 1 preferably comprises an area 2 serving as a grip for the operator, an activation switch 3 and an end portion 4 where the plasma is generated.

The grip area 2 preferably comprises two half shells, a lower half shell 2a and an upper half shell 2b, coupled together.

In variant embodiments, the grip area can be carried out in a different way, for example it can comprise two half shells, a right one and a left one, coupled together, or preferably comprise a single tubular shell.

In the continuation of the present description reference is made especially to the end portion 4 of the torch 1, referring more specifically to Figures from 3 to 6 which schematically illustrate the cross section of the end portion 4 of the torch 1, with the cooling system according to the present invention.

In said end portion 4 of the torch 1 it is possible to identify a supporting element 12 whose underside is coupled with the element 14, known in the art as shield cup body. The underside of the shield cup body 14 is in turn coupled with the element 15, known in the art as shield. The shield 15 is provided with an opening 15a. The shield 15 is preferably coupled with the shield cup body 14 through a screwing operation. It is evident that in variant embodiments said coupling can be carried out in a different manner.

The lower area 14b of the shield cup body 14 supports, in its inner part, a nozzle provided with an orifice 21 from which the carrier gas can be diffused towards the outside after the ionization process, as is explained in greater detail below.

In the embodiment illustrated herein, the nozzle 20 constitutes a first element designed to collimate and convey the plasma flow. Furthermore, the nozzle 20 is conveniently piloted electrically so that it can serve the function of an anode in the initial striking step for the generation of the plasma through the ionization of the carrier gas. Said function of serving as an anode is then transferred to the piece being processed, while the nozzle 20 serves only as an element intended to collimate and convey the plasma flow.

In the different striking and processing steps, the torch 1 is managed and piloted by a control unit (not shown in the figures).

The nozzle 20 is preferably made of a conductive material, preferably with high thermal resistance, more specifically resistant to high temperatures. The nozzle 20 is preferably made of copper. In variant embodiments, the nozzle is made of a copper alloy, that is, a copper alloy whose surface is treated in order to increase its hardness and resistance to the molten material produced by the cutting operation. In other variant embodiments, the use of brass can also be envisaged.

Inside the shield cup body 14 it is also possible to identify the element 22, known in the art as diffuser. The diffuser 22 is associated with the upper part of the nozzle 20.

Coaxially with and inside the diffuser 22 there is an internal electrode 19. The internal electrode 19 of the embodiment described herein constitutes the second electrode (cathode) designed for the generation of the electric arc and of the plasma through the ionization of the carrier gas.

In variant embodiments of the invention such as, for example, in the case of a torch based on non-transferred arc technology, the internal electrode constitutes the cathode, while the first element, constituted by the nozzle 20, serves the function of an anode during both the initial striking step and the piece processing step.

The internal electrode 19 develops along a main axis X and is hollow.

In fact, the electrode 19 comprises a cavity 25 that develops along said main axis X.

The cavity 25 preferably and substantially extends over the entire length of the electrode 19.

Preferably, at the level of the lower end 19a of the internal electrode 19 there is an insert 90 made of an electrically conductive material and preferably characterized by high thermal resistance.

The materials used preferably comprise tungsten and hafnium.

The insert 90 is positioned centrally in the lower end 19a of the internal electrode 19, where the electric arc is concentrated. The special electrical resistance characteristics of the insert 90 make it possible to extend the duration/life of the internal electrode 19 over time.

In variant embodiments, however, said cavity can have sizes and shapes different from those illustrated herein.

Preferably, the lower end 19a of the internal electrode 19 extends at least partially inside the nozzle 20.

The internal electrode 19 preferably slides along the main axis X. This is obtained by using a piston 17 coupled with the internal electrode 19. The piston 17 substantially develops along the main axis X and is maintained under a thrusting action towards the nozzle 20 by elastic thrusting means 26. The elastic thrusting means 26 preferably comprise a spiral spring 26.

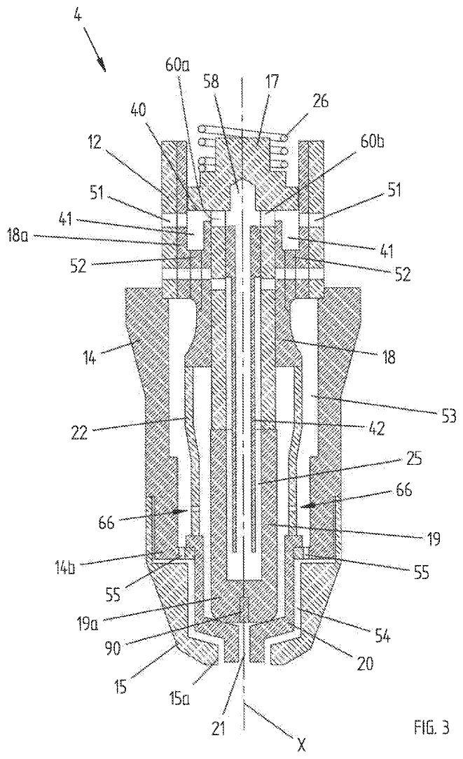

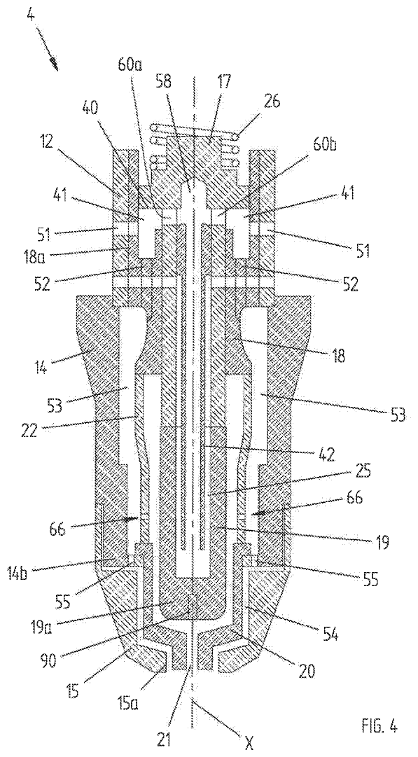

The piston 17 and the internal electrode 19 can assume, in particular, a first operating configuration, shown in FIG. 3, in which the spiral spring 26 exerts its thrusting action and the internal electrode 19 is in contact with the inner surface of the nozzle 20.

In said first operating configuration, the orifice 21 of the nozzle 20 is substantially obstructed and the two electrodes, the anode constituted by the nozzle 20 and the cathode constituted by the internal electrode 19, are electrically in contact with each other and in a non-striking condition.

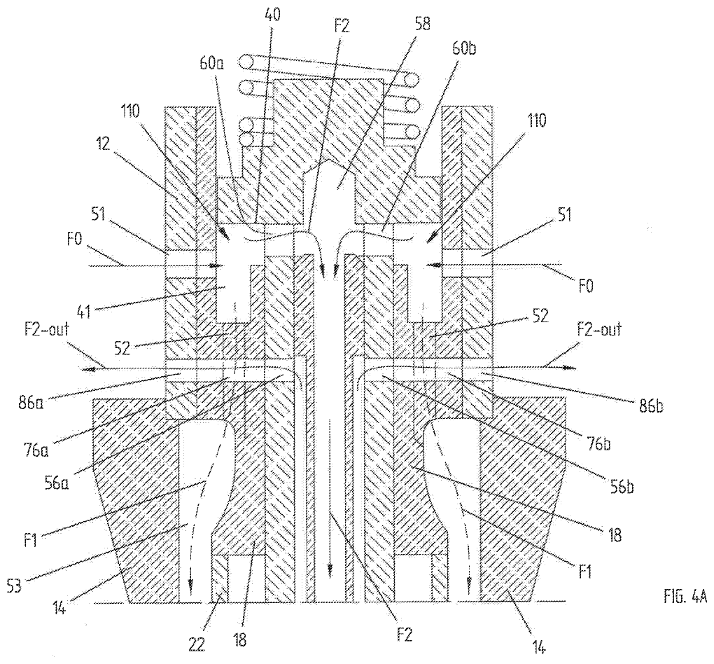

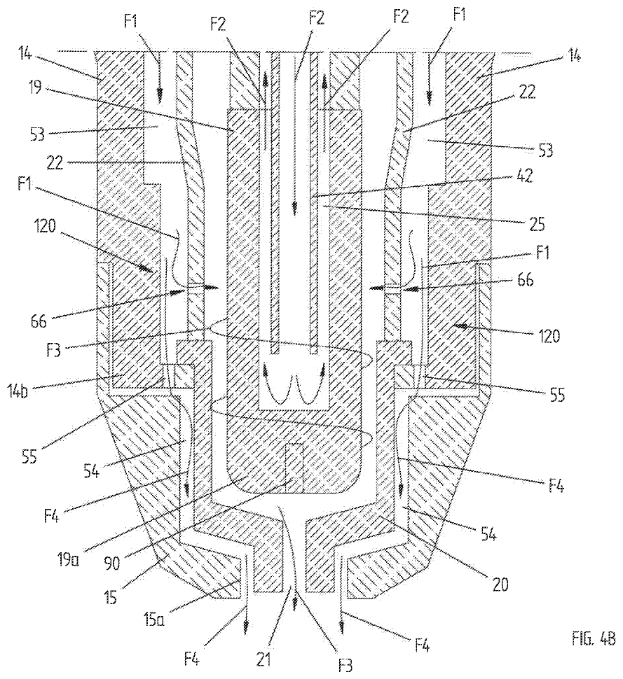

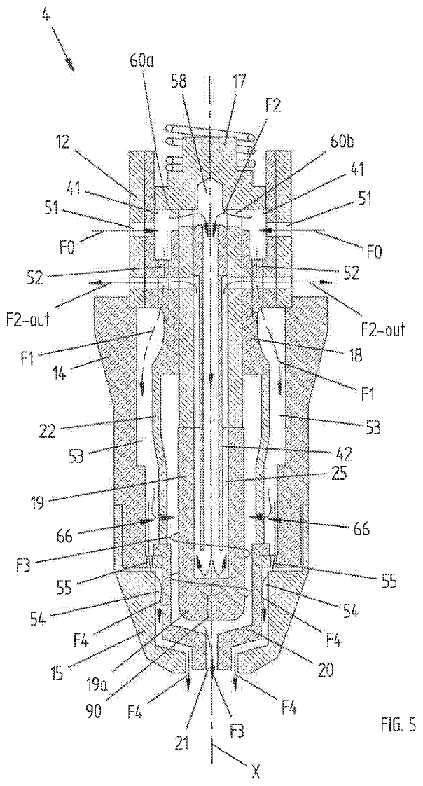

The piston 17 and the internal electrode 19 can then assume a second operating configuration, shown in FIGS. 4, 5 and 6, in which the spiral spring 26 is compressed and the internal electrode 19 is at a suitable distance from the inner surface of the nozzle 20. Said distance is the distance at which the electric arc between the two electrodes 20, 19 is initiated. In said second operating configuration, the orifice 21 is free and, with the torch in operation, the plasma can flow out towards the outside once the electric arc has reached the material to be cut.

The first and the second operating configuration of the two electrodes 20, 19 are obtained through the methods illustrated below.

Advantageously, the piston 17 is slidingly housed inside the supporting element 12.

A part of the piston 17, moreover, is slidingly supported by a central bushing 18.

An annular chamber 41 is preferably defined between the upper part 18a of the bushing 18 and the piston 17, and radial ducts 60a, 60b created in the piston 17 connect the annular chamber 41 with an inner cavity 58 of the piston 17.

A tubular conveyance element 42 is axially positioned inside the internal electrode 19, in its inner cavity 25. Preferably, said tubular conveyance element 42 is connected to the central piston 17 and preferably extends substantially over the entire length of the inner cavity 25 of the internal electrode 19.

In variant embodiments, however, the tubular conveyance element can have sizes and shapes different from those illustrated herein.

Advantageously, on parts of the elements just illustrated and described there are suitable conveyance ducts or ways suited to allow the carrier gas to be conveyed for the operation of the torch, as described below.

In addition to conveying the carrier gas, the elements that make up the torch 1 also guarantee the electrical connection of the anode (nozzle 20) and the cathode (internal electrode 19) to the power supply unit. The details of such connections are neither described herein nor illustrated in the drawings.

The electrical connection of the nozzle 20 to the power supply unit, however, is guaranteed by the electrical continuity provided by the material of which the shield cup body 14 and the supporting element 12 are made, the latter being conveniently connected to an electric cable, not shown, coming from the power supply unit.

The electrical connection of the internal electrode 19 to the power supply unit is guaranteed by the electrical continuity provided by the material with which the piston 17 is made, the latter being conveniently connected to an electrical cable, not shown, coming from the power supply unit. Furthermore, the materials of which the central bushing 18 and the diffuser 22 are made create and guarantee the necessary electrical insulation between the two electrodes (cathode and anode 19).

In the end portion 4 of the torch 1 it is possible to identify a main conveyance way F0 suited to convey the carrier gas (air) coming from the feeding unit through the grip area 2 of the torch 1. The main way F0 preferably comprises a first duct 51 which affects the supporting element 12 and the upper part 18a of the central bushing 18.

The air is conveyed from the main way F0 into the annular chamber 41 through the first duct 51 and in said annular chamber 41 the compressed air exerts a thrusting action on an annular edge 40 of the piston 17.

The piston 17 is thus thrusted against the force of the spiral spring 26 and the torch 1 is therefore brought from the first non-striking operating configuration, shown in FIG. 3, to the second striking operating configuration, shown in FIGS. from 4 to 6.

The annular chamber 41 is associated with first dividing means 110, better visible in FIG. 4A, suited to divide the main way F0 into a first conveyance way F1 suited to convey a portion of the air from the main way F0 towards the striking area and into a second conveyance way F2 suited to convey a portion of the air from the main way F0 towards the inner cavity 25 of the hollow electrode 19. The second way F2, as is better described below, is advantageously suited to cool down the hollow electrode 19.

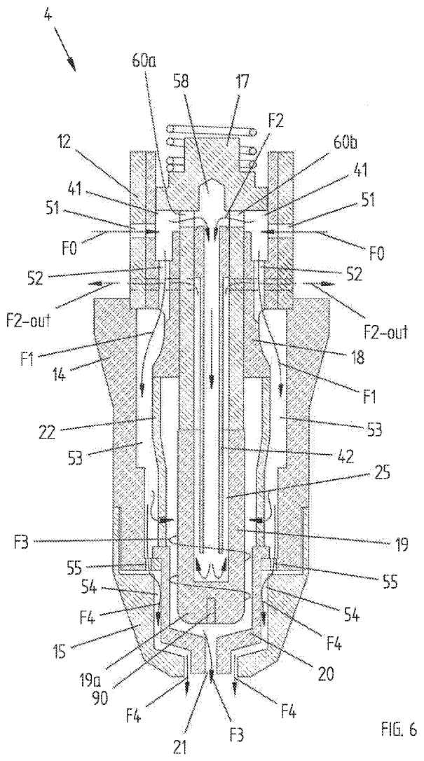

The first dividing means 110 preferably comprise:
one or more ducts 52 (clearly visible in the sectional view shown in FIG. 6), created in the central bushing 18, which connect the annular chamber 41 with a first gap area 53 defined between the shield cup body 14 and the diffuser 22;
radial ducts 60a, 60b, created in the piston 17, which connect the annular chamber 41 with an inner cavity 58 of the piston 17.

Downstream of the ducts 52 created in the central bushing 18 it is thus possible to identify the first way F1 and downstream of the radial ducts 60a, 60b of the piston 17 it is thus possible to identify the second way F2.

The first gap area 53 is also associated with second dividing means 120, better visible in FIG. 4B, suited to divide the first way F1 into a third conveyance way F3 suited to convey a portion of the air from the first way F1 towards the striking area and into a fourth conveyance way F4 suited to convey a portion of the air from the first way F1 towards the first element 20. The fourth way F4 is advantageously suited to cool down the first element 20.

During operation, the four ways F1, F2, F3 and F4 are crossed by corresponding air flows F1, F2, F3 and F4.

The second dividing means 120 preferably comprise:
one or more openings 66 defined in the side walls of the diffuser 22 and connecting the first gap area 53 with the area inside the diffuser 22;
one or more ducts 55 created in the lower end 14b of the shield cup body 14 and connecting the first gap area 53 with a second gap area 54 defined between the shield 15 and the nozzle 20.

Downstream of the openings 66 in the diffuser 22 it is thus possible to identify the third conveyance way F3 and downstream of the ducts 55 of the shield cup body 14 it is thus possible to identify the fourth conveyance way F4.

The openings 66 are preferably and conveniently shaped in such a way as to transmit a rotary motion to the third air flow F3 in order to create in the air the spiral-shaped movement which then allows the plasma to exert its penetrating action in the piece to be cut.

In fact, the third flow F3 is conveyed between the nozzle 20 and the internal electrode 19 and thus towards the orifice 21. Said third flow F3 defines the gas flow suited to be ionized by the action of the electric arc in the striking area between the nozzle 20 and the internal electrode 19 for the generation of the plasma. Then, the plasma flows out of the orifice 21 towards the outside.

On the other hand, the fourth flow F4 of compressed air advantageously constitutes a cooling flow for the nozzle 20.

Going back to the second way F2 suited to cool down the electrode 19, the second flow F2 flows from the inner cavity 58 of the piston 17 into the tubular conveyance element 42 and is directed towards its lower end and in proximity to the lower end 19a of the electrode 19, as shown, for example, in FIG. 4B.

From here, the second flow F2 moves upwards through the cavity 25, inside the electrode 19 and outside the tubular conveyance element 42. Along this path, the second air flow F2 serves as a cooling fluid for the inner surfaces of the electrode 19 with which it comes into contact.

The second air flow F2 then reaches an outlet way F2-out. In the embodiment illustrated herein, said outlet way F2-out is defined by two ducts 56a and 56b created in an intermediate area of the piston 17, by two ducts 76a, 76b created in the central bushing 18 and by two ducts 86a, 86b created in the supporting element 12 (as can be seen in FIG. 4A).

The second flow F2 constituted by the heated air coming from the cavity 25 of the electrode 19 is conveyed and ejected towards the outside through said outlet way F2-out.

In variant embodiments of the invention, said way may be defined by a different number of ducts, conveniently configured to convey the air towards the outside of the torch 1.

Furthermore, in different variant embodiments of the invention, the various ducts which constitute the communication ways for the air flows illustrated above can have shapes and positions different from those illustrated and described herein.

Analogously, also the number of said ducts can be different from the number specified herein.

Advantageously, the second flow F2 of heated air coming from the cavity 25 of the internal electrode 19 is ejected towards the outside through the outlet way F2-out and no more directed towards the striking area, in such a way as to avoid any interference with the striking area defined between the nozzle 20 and the electrode 19.

In this way, the cooling efficiency for the internal electrode 19 is improved.

Even the cooling efficiency for the nozzle 20 is improved compared to the torches of the known type.

This results in reduced wear of the consumable elements 20, 19 and in reduced need for maintenance and/or replacement operations.

Furthermore, the direction of the second air flow F2 conveyed inside the electrode 19 from the tubular conveyance element 42 towards the lower end of the electrode 19a favours the ejection of residues at the end of the operating life of the electrode 19, in particular in case of complete deterioration of the insert 90 emitting the arc current, with the consequent possible fragmentation of both the insert 90 and the lower end 19a of the internal electrode 19 which receives the insert 90 itself.

Consequently, the maintenance and/or replacement costs related to the tubular conveyance element 42 are reduced compared to those required by the torches of the known type.

Advantageously, also the maintenance and/or replacement costs related to the electrode and/or the electrodes are reduced compared to those required by the torches of the known type.

The operation described above, with the generation of plasma by the torch 1, continues as long as the torch is fed with the air (carrier gas) flow coming from the main way F0, or first duct 51, that is, as long as the torch 1 is in its second operating configuration. In the moment when the air flow coming from the main way F0, or first duct 51, is interrupted, for example deactivating the switch 3, the thrusting force exerted on the annular edge 40 of the piston 17 decreases and the spiral spring 26 exerts its thrusting force bringing the torch 1 in its first operating configuration with the piston 17 and the internal electrode 19 in the non-striking position, as previously described.

It has thus been shown through the present description that the torch according to the present invention makes it possible to achieve the set objects. More specifically, the torch according to the present invention makes it possible to improve the cooling efficiency compared to the systems used in the torches of the known type.

Even though the present invention has been illustrated above through the detailed description of an embodiment represented in the drawings, the present invention is not limited to the embodiment described above and represented in the drawings; on the contrary, further variants of the embodiments described herein can fall within the scope of the present invention, which is defined in the claims.

1. -13. (canceled)

14. A plasma torch comprising:
a first element provided with a through opening for the exit of a plasma flow;
a hollow electrode which develops longitudinally along a main axis and can be positioned with respect to said first element in such a way as to define a striking area, said hollow electrode being of the type comprising an inner cavity that extends at least partially along said main axis;
a main conveyance way suited to convey a carrier gas;
first dividing means suited to divide said main way into a first conveyance way suited to convey a portion of said carrier gas from said main way towards said striking area and a second conveyance way suited to convey a portion of said carrier gas from said main way towards said inner cavity of said hollow electrode, said portion of said carrier gas of said second way being suited to cool down said hollow electrode, and the entirety of said portion of said carrier gas of said second way being conveyed from said inner cavity of said hollow electrode towards an outlet way in such a way as not to affect said striking area;
second dividing means arranged downstream of said first dividing means and suited to divide said first way into a third conveyance way suited to convey a portion of said carrier gas from said first way towards said striking area and into a fourth conveyance way suited to convey a portion of said carrier gas from said first way towards said first element, said portion of said carrier gas of said fourth way being suited to cool down said first element;
a shield body cup which supports said first element;
a shield provided with an opening coupled with the shield body cup; and
a gap area defined between the shield and the first element.

15. The plasma torch according to claim 14, wherein the outlet way conveys said carrier gas from said inner cavity of said hollow electrode in said second way towards the outside of said torch, in such a way as not to affect said striking area.

16. The plasma torch according to claim 14, wherein said inner cavity of said hollow electrode substantially extends over the entire length of said hollow electrode.

17. The plasma torch according to claim 14, wherein said hollow electrode constitutes the cathode of said torch.

18. The plasma torch according to claim 14, wherein said hollow electrode constitutes the cathode of said torch and said first element constitutes the anode of said torch.

19. The plasma torch according to claim 14, wherein said hollow electrode is movable and can be positioned between at least one first operating position and at least one second operating position, wherein in said first operating position said hollow electrode is in contact with said first element and in said second operating position said hollow electrode is spaced from said first element in such a way as to define said striking area.

20. The plasma torch according to claim 19, further comprising moving means suited to move said hollow electrode between said at least one first operating position and said at least one second operating position.

21. The plasma torch according to claim 20, wherein said moving means comprise at least one supporting piston suited to support said hollow electrode and elastic thrusting means suited to thrust said piston and to arrange said hollow electrode in said at least one first operating position.

22. The plasma torch according to claim 14, wherein said hollow electrode is in a fixed position with respect to said first element.

23. The plasma torch according to claim 14, further comprising power supply means for said hollow electrode.

24. The plasma torch according to claim 14, further comprising power supply means for said first element.

25. A device for the generation of plasma comprising a plasma torch, wherein said plasma torch is made according to claim 14.

26. An operating method for a plasma torch, the plasma torch including:
a first element provided with a through opening for the exit of a plasma flow;
a hollow electrode that develops longitudinally along a main axis and can be positioned with respect to said first element in such a way as to define a striking area, said hollow electrode being of the type comprising an inner cavity that extends at least partially along said main axis;
a main conveyance way suited to convey a carrier gas;
a shield body cup which supports said first element;
a shield provided with an opening coupled with the shield body cup; and
a gap area defined between the shield and the first element. said method comprising:
conveying a portion of said carrier gas from said main way towards said striking area along a first way and conveying a portion of said carrier gas from said main way towards said inner cavity of said hollow electrode to cool down said hollow electrode along a second way, the entirety of said portion of said carrier gas being conveyed from said inner cavity of said hollow electrode towards an outlet way, so as not to affect said striking area; and
conveying a portion of said carrier gas from said first way towards said striking area along a third way and conveying a portion of said carrier gas from said first way towards said first element along a fourth way, said portion of said carrier gas of said fourth way being suited to cool down said first element.
